(19) United States
(12) Patent Application Publication
(10) Pub. No.: US 2019/0387127 A1
(43) Pub. Date: Dec. 19, 2019

(54) INFORMATION PROCESSING APPARATUS, CONTROL METHOD OF INFORMATION PROCESSING APPARATUS, AND PROGRAM

(71) Applicant: CANON KABUSHIKI KAISHA, Tokyo (JP)

(72) Inventor: Tsutomu Kubota, Abiko-shi (JP)

(21) Appl. No.: 16/432,806

(22) Filed: Jun. 5, 2019

(30) Foreign Application Priority Data
Jun. 14, 2018 (JP) 2018-113944

(51) Int. Cl. H04N 1/44; H04N 1/00

(52) U.S. Cl. CPC H04N 1/444; H04N 1/00129; H04N 2201/0094; H04N 1/00421; H04N 1/00209

(57) ABSTRACT

An information processing apparatus with a plurality of network interfaces includes: at least one controller configured to function as; a unit that associates network information related to any one of the plurality of network interfaces with a folder that stores data; a unit that determines, based on at least the network information, whether or not to permit an external device that communicates with the information processing apparatus via a network corresponding to the network information to perform predetermined communication relating to the folder.

### BACKGROUND OF THE INVENTION

### Field of the Invention

The present disclosure relates to an information processing apparatus, a control method of the information processing apparatus, and a program.

### Description of the Related Art

There is conventionally known an information processing apparatus equipped with a plurality of network interfaces (Japanese Patent Laid-Open No. 2002-342041). Such an information processing apparatus can be connected to a separate network for each interface, so that the information processing apparatus can be shared among a plurality of organizations using different networks, for example. An example of an apparatus shared among a plurality of organizations is a multi-function peripheral having a scan function and a print function. Such a multi-function peripheral often has a box function for storing image data obtained by scanning an original document and image data transmitted from a PC or the like via a network. When an apparatus that stores data is shared among a plurality of organizations, data of one organization may leak to the other organization.

### SUMMARY OF THE INVENTION

An aspect of the present disclosure is to improve the security of an apparatus including a plurality of network interfaces.

Another aspect of the present disclosure is to, in an information processing apparatus having a plurality of network interfaces shared among a plurality of organizations, provide a mechanism for reducing the risk of leakage of data from one organization to the other.

A further aspect of the present disclosure is to provide an information processing apparatus with a plurality of network interfaces including: at least one controller configured to function as, a unit that associates network information related to any one of the plurality of network interfaces with a folder that stores data; a unit that determines, based on at least the network information, whether or not to permit an external device that communicates with the information processing apparatus via a network corresponding to the network information to perform predetermined communication relating to the folder.

Further features of the present disclosure will become apparent from the following description of exemplary embodiments (with reference to the attached drawings).

### BRIEF DESCRIPTION OF THE DRAWINGS

FIG. 1 is a block diagram illustrating an example of an image processing apparatus.

FIG. 2 is a system configuration diagram illustrating an example of a system to which the image processing apparatus is connected.

FIG. 3 is an example of a network security policy setting screen.

FIG. 4 is an example of a network security policy setting screen.

FIG. 5 is an example of a network security policy setting screen.

FIG. 6 is a diagram of a login screen when a PC remotely accesses the image processing apparatus via a network.

FIG. 7 is a diagram of a login screen for logging in from an operation unit.

FIG. 8 is a diagram of a function selection screen.

FIG. 9 is a diagram with a folder function selected.

FIG. 10 is a screen display example in which storage is selected in a file operation function.

FIG. 11 is a screen display example in which copy is selected in the file operation function.

FIG. 12 is a screen display example in which transmission is selected in the file operation function.

FIG. 13 is a diagram illustrating an operation flow of network security policy setting.

FIG. 14 is a diagram illustrating a process flow of a login operation.

FIG. 15 is a diagram illustrating a process flow of a file storage operation.

FIG. 16 is a diagram illustrating a process flow of a file copy operation.

FIG. 17 is a diagram illustrating a process flow of a file transmission operation.

### DESCRIPTION OF THE EMBODIMENTS

Hereinafter, the best mode for carrying out the present disclosure will be described with reference to the drawings.

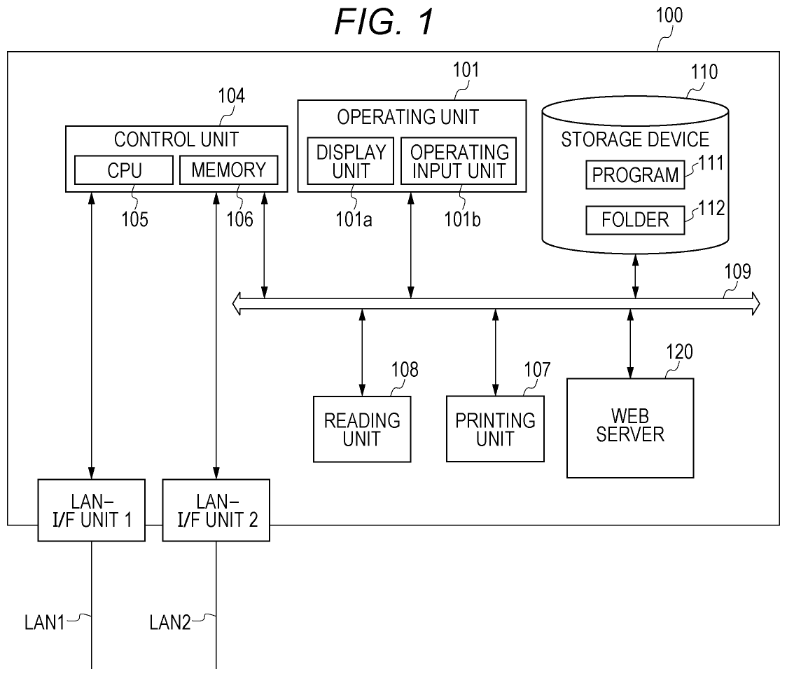

FIG. 1 is a block diagram illustrating an example of an MFP 100 which is an example of an information processing apparatus according to an embodiment. MFP is an abbreviation of multi function peripheral.

The image processing apparatus 100 includes an operation unit 101, a LAN-I/F unit 1, and a LAN-I/F unit 2. The image processing apparatus 100 further includes a control unit 104, a reading unit 108, a printing unit 107, a storage device 110, and a web server, which are connected by a bus 109.

The control unit 104 includes a CPU 105 and a memory 106. The CPU 105 performs centralized control of the MFP by reading a program 111 from the storage device 110 into a memory 106 and executing the program 111. The memory 106 is formed from a random access memory (RAM) or the like. The program may be stored in a read only memory (ROM) not illustrated.

The operation unit 101 includes a display unit 101a and an operation input unit 101b. The display unit 101a is formed from a liquid crystal display unit, and the display on the display unit 101a is controlled by the CPU 105. The display unit 101a displays operation screens of the MFP and screens illustrating the status of the MFP. The operation input unit 101b is formed from a keyboard or a touch panel provided on the display unit 101a.

The storage device 110 is formed from a hard disk drive (HDD) or the like. The storage device 110 stores the program 111, image data, other databases, and the like. The storage device 110 can also store a folder 112.

The reading unit 108 is a scanner that reads an image in an original document and generates image data based on the read image. The generated image data is stored in the storage device 110.

The printing unit 107 is a printer that prints an image on a paper sheet based on image data.

The web server 120 receives a request from a browser of an external PC, generates a web page in XML or HTML format, and transmits the web page to the PC that has transmitted the request.

The LAN-I/F unit 1 is a network interface, which controls transmission and reception of data between a LAN 1 and the MFP 100. The LAN-I/F unit 2 is a network interface, which controls transmission and reception of data between a LAN 2 and the MFP 100.

As described above, the MFP 100 according to the present embodiment has a plurality of network interfaces for direct connection to a plurality of networks.

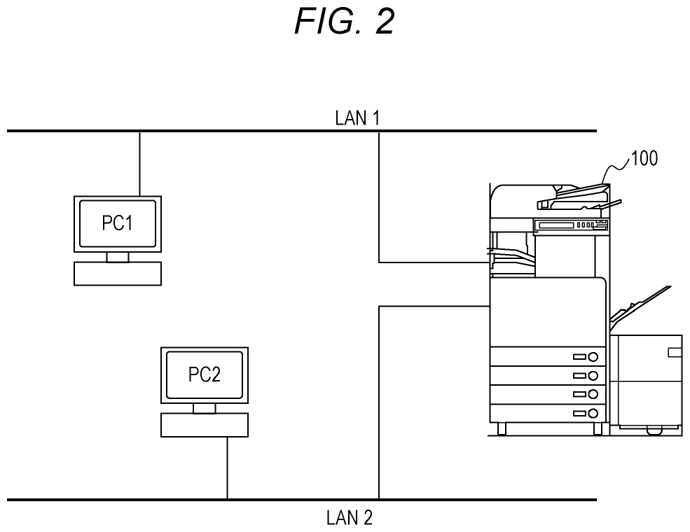

Next, an example of an information processing system in which the MFP 100 is connected to a plurality of networks will be described with reference to FIG. 2.

Referring to FIG. 2, the MFP 100 is connected to the LAN 1 and the LAN 2.

A PC 1 is connected to the LAN 1, and a PC 2 is connected to the LAN 2.

Such an information processing system is useful for using the MFP 100 in a plurality of organizations while separating respective networks in the organizations from each other.

Since the MFP 100 does not transfer data between the LAN 1 and the LAN 2, folders and files stored in a file server of the LAN 2 (not illustrated) cannot be viewed from the PC 1, for example. In addition, folders and files stored in a file server of the LAN 1 (not illustrated) cannot be viewed from the PC 2.

By sharing the MFP in a plurality of organizations while separating their respective networks to maintain the security between the LANs, it is possible to reduce the cost for purchasing the MFP as compared to the case of purchasing the MFP by each of the organizations.

The MFP also has a box function of accepting a user's operation from the operation unit 101 and storing image data indicating an image of an original document read by the reading unit 108 in the storage device 110. The box function has a plurality of folders (storage areas), and the image data indicating the image of an original document is stored in a folder selected by the user before reading the original document. After that, the user selects the folder, selects the image data to be printed, and issues a print instruction, thereby to cause the printing unit 107 to print an image based on the image data. The box function can also store image data received from an external PC.

However, it is not preferable for security that the image data stored in the storage device 110 as described above is transmitted as a web page by the web server 120 according to a request from the PC 1 of the LAN 1 so that the web page can be viewed without limitation from the user of the PC 1. In addition, it is not preferable for security that a web page is transmitted by the web server 120 according to a request from the PC 2 of the LAN 2 so that the web page can be viewed without limitation from the user of the PC 2.

Therefore, in the present embodiment, it is made possible to set, for each folder, from which LAN to accept viewing and operations.

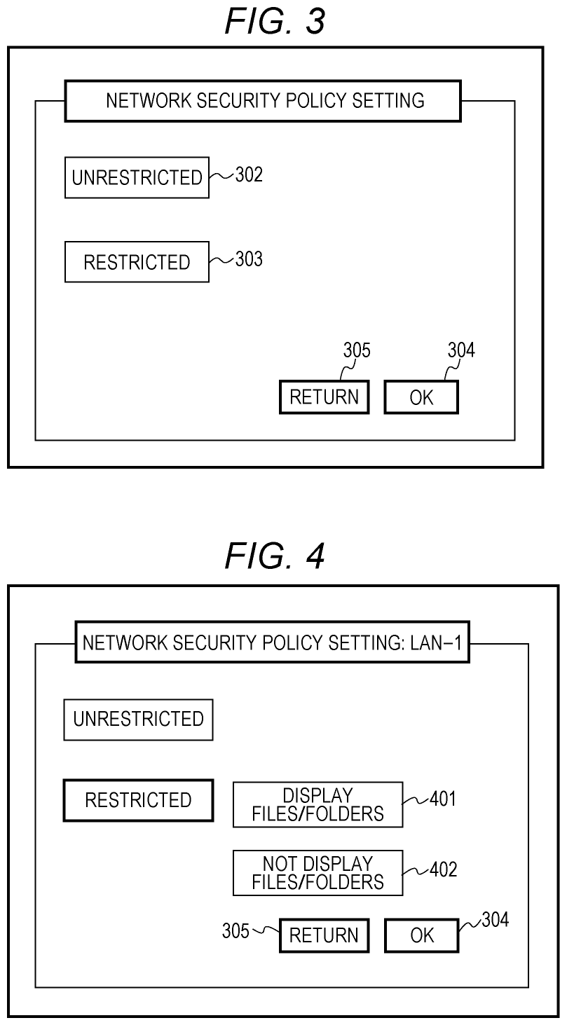

FIG. 3 is an example of a screen displayed on the display unit 101a of the MFP 100.

The screen illustrated in FIG. 3 is a screen for setting whether or not to restrict access to folders and files created in the storage device 110.

When an unrestricted button 302 is selected, the use of folders and files in the storage device 110 is not restricted.

When a restricted button 303 is selected, a screen illustrated in FIG. 4 appears on the display unit 101a of the MFP 100 to allow the user to select whether to display or not to display files and folders. When “display files/folders” 401 is selected, viewing of the files and folders in the storage device 110 is not prohibited, and printing and transmission of the files is prohibited under conditions described later. When “not display files/folders” 402 is selected, viewing of the files and folders is prohibited under the conditions described later.

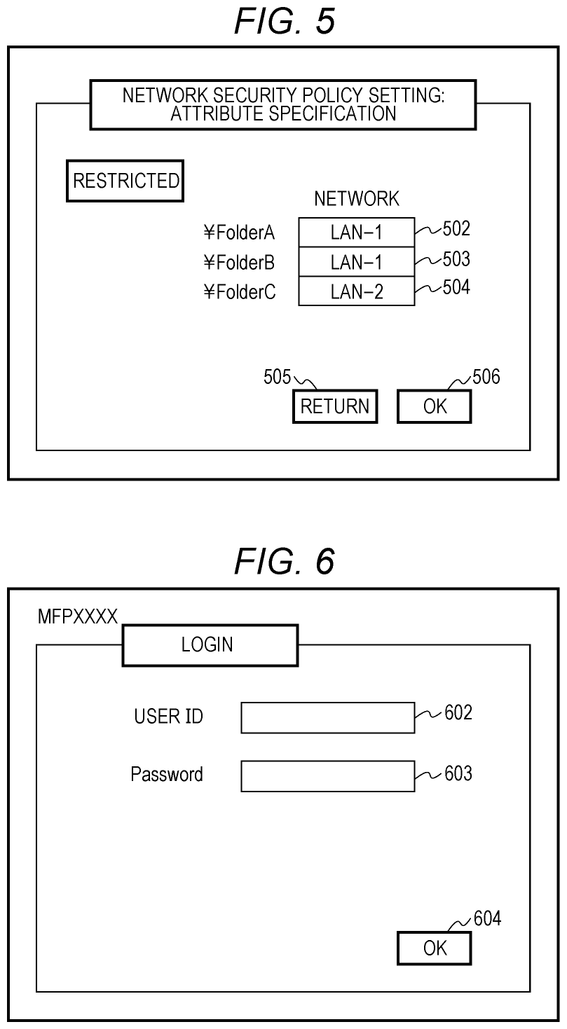

A back button 305 is a button for closing the screen without reflecting the settings illustrated in FIG. 3 or 4. On the other hand, an OK button 304 is a button for confirming the settings illustrated in FIG. 3 or 4. When the restricted button 303 is selected and the OK button 304 is pressed, a screen illustrated in FIG. 5 appears on the display unit 101a of the MFP 100.

FIG. 5 illustrates a screen for setting network attributes to folders. Referring to FIG. 5, when the screen appears, folder names of folders stored in the storage device 110 are presented in a list.

It is assumed in this example that three folders, Folder A, Folder B, and Folder C, are stored in the storage device 110.

The user operates pull-down menus 502 to 504 for the folders to assign network attributes to the folders.

In the example of FIG. 5, the LAN 1 is set to the Folder A from the pull-down menu 502. This setting can be changed to the LAN 2 from the pull-down menu 502.

In the example of FIG. 5, the LAN 1 is set to the Folder B from the pull-down menu 503. This setting can be changed to the LAN 2 from the pull-down menu 503.

In the example of FIG. 5, the LAN 2 is set to the Folder C from the pull-down menu 504. This setting can be changed to the LAN 1 from the pull-down menu 504.

A back button 505 is a button for closing the screen of FIG. 5 without reflecting the settings on the screen of FIG. 5. An OK button 506 is a button for storing the settings on the screen of FIG. 5 in the storage device 110 and closing the screen of FIG. 5.

When the network attributes are added to the folders via the screen of FIG. 5, the same network attributes are automatically added by the CPU 105 to the files stored in the folders.

An example of data stored in the storage device 110 as described above is shown below.

TABLE 1

| Folder | Network |
|---|---|
| Folder 1 | LAN 1 |
| Folder 2 | LAN 1 |
| Folder 3 | LAN 2 |

The storage device 110 has accounts of users of the MFP 100 registered as shown in Table 2 below. These accounts may be registered using the operation unit 101 or may be registered from the PC of the administrator.

TABLE 2

| User ID | Password | Network information |
|---|---|---|
| User 1 | abc | LAN 1 |
| User 2 | fef | LAN 2 |
| User 3 | xxd | LAN 1, LAN 2 |
| User 4 | def | LAN 2 |
| User 5 | xyz | LAN 1 |

Table 2 illustrates, for each of the users, a user name, a password, and network information available to the user. The user name and password are used for authentication of the user to log into the MFP 100.

FIG. 6 illustrates an example of a login screen displayed on the operation unit 101 of the MFP 100. On the login screen, a user ID input field 602, a password input field 603, and an OK button 604 are displayed.

The user inputs a user ID in the user ID input field 602 via the operation unit 101 of the MFP 100, inputs a password in the password input field 603, and presses the OK button 604.

When the OK button 604 is pressed, the CPU 105 searches Table 2 for the combination of the input user ID and password. When the combination is not found, the CPU 105 does not allow the user to log into the MFP 100. On the other hand, when the input user ID and password are found in Table 2, the CPU 105 allows the user to log into the MFP 100.

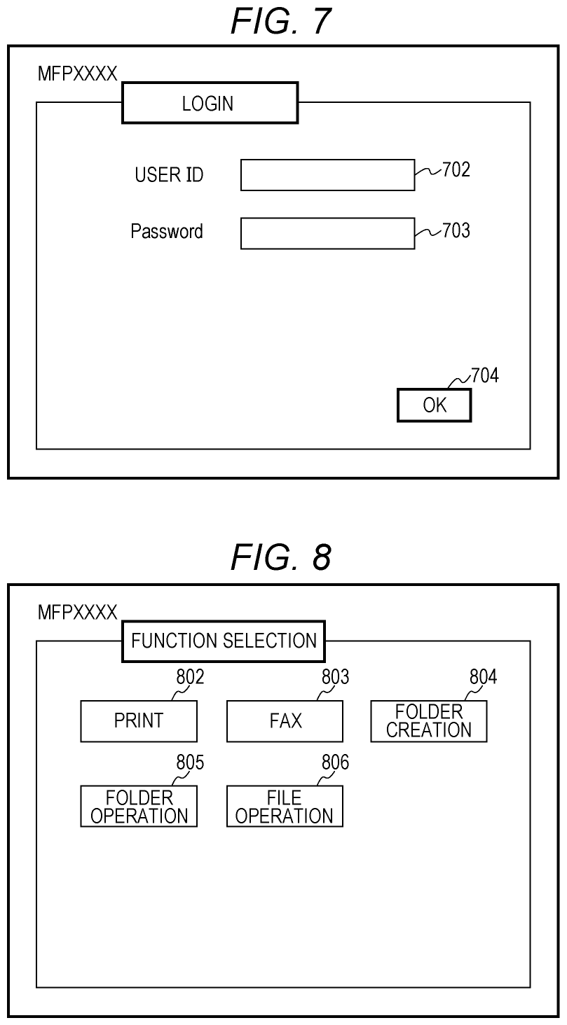

Alternatively, the user can display the screen of FIG. 7 on the browser of the PC and log into the MFP 100 based on the user ID and password accepted on the screen of FIG. 7. In this case, the screen of FIG. 7 is generated by the web server 120 of the MFP 100 that has received a request from the PC, then transmitted to the PC as screen information in HTML or XML format, and then displayed on the PC. Also for each of the subsequent screens displayed on the browser of the PC, the web server 120 of MFP 100 receives a request from the PC and transmits the screen to the PC as screen information in HTML or XML format, so that the screen is displayed on the PC.

On the screen of FIG. 7, a user ID input field 702, a password input field 703, and an OK button 704 are displayed. The user uses the operation unit of the PC to input the user ID in the user ID input field 702 and input the password in the password input field 703, and selects the OK button 704. When the OK button 704 is pressed, the CPU 105 searches Table 2 for the combination of the input user name and password. When the combination is not found, the CPU 105 does not allow the user of the PC to log into the MFP 100. On the other hand, when the input user ID and password are found in Table 2, the CPU 105 allows the user of the PC to log into the MFP 100.

The network information in Table 2 indicates to which of the organizations LAN1 and LAN2 each user belongs. The network information indicates that a user 1 belongs to the organization LAN 1, and a user 2 belongs to the organization LAN 2.

Both the LAN1 and LAN2 may be assigned to a user who belongs to both the organizations such as a user 3. In addition, both the LAN 1 and the LAN 2 may be assigned to the administrator of the MFP 100.

FIG. 8 illustrates an example of a function selection screen displayed on the browser of the PC after the user of the PC logs into the MFP 100 via the screen of FIG. 7.

The function selection screen includes a print button 802, a FAX button 803, a folder creation button 804, a folder operation button 805, and a file operation button 806.

The user of the PC operates the operation unit of the PC to select one of these buttons.

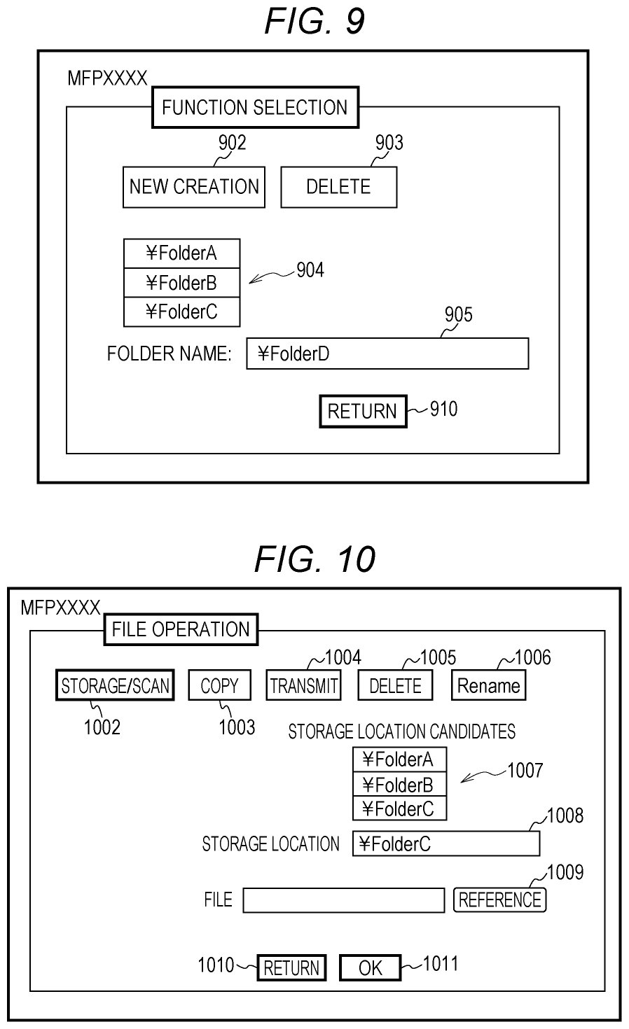

FIG. 9 illustrates an example of a screen displayed on the browser of the PC when the folder operation 805 is selected on the screen of FIG. 8. The screen illustrated in FIG. 9 includes a new creation button 902 and a delete button 903. In addition, the screen also presents the information of Folder A. Folder B. and Folder C stored in the storage device 110.

The new creation button 902 is a button for creating a new folder. After the folder name is input in a folder name input field 905, when the new creation 902 is selected, a new folder is created under the input folder name in the storage device 110.

The delete button 903 is a button for deleting a selected folder by being pressed in a state where any one of Folder A, Folder B, and Folder C is selected by a folder selection button 904.

A back button 910 is a button for returning to the screen of FIG. 8.

FIG. 10 illustrates an example of a screen displayed on the browser of the PC when the file operation 806 is selected on the screen of FIG. 8. The screen of FIG. 10 includes a storage button 1002, a copy button 1003, a transmit button 1004, a delete button 1005, a rename button 1006, a reference button 1009, a back button 1010, and an OK button 1011.

On the screen of FIG. 10, the storage button 1002 is selected and a setting screen related to the storage function is displayed.

When the user selects any of Folder A, Folder B, and Folder C from storage location candidates, the folder name of the storage location folder is displayed in a storage location display field 1008.

The user operates the reference 1009 to select a file to be stored in the folder from the storage unit (HDD or the like) of the PC.

Then, when the OK button 1011 is selected, the file selected by operating the reference button 1009 is transmitted from the PC to the MFP, and is stored in the storage location selected by the folder selection button 1007.

The back button 1010 is a button for returning to the screen of FIG. 8.

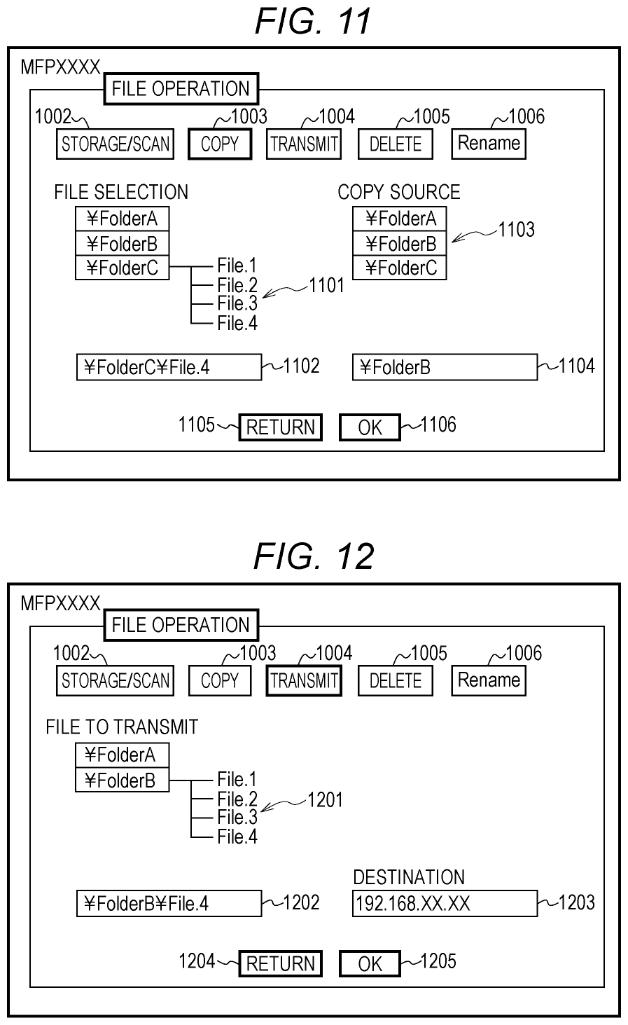

FIG. 11 illustrates an example of a screen displayed on the browser of the PC when the copy button 1003 is selected on the screen of FIG. 8. The screen of FIG. 11 includes a storage button 1002, a copy button 1003, a transmit button 1004, a delete button 1005, a rename button 1006, a back button 1105, and an OK button 1106.

The screen of FIG. 11 illustrates a state in which Folder C is selected in a file selection area 1101 and a list of files stored in Folder C is displayed. The user selects a file to be copied from among files 1 to 4. When the file is selected, the file name of the selected file is displayed in a file name display field 1102. The user also selects the copy destination of the file from a copy destination list 1108. The selected copy destination is displayed in a copy destination display field 1104.

Then, when the OK button 1106 is selected, the selected file is copied (duplicated) to the selected copy destination.

The back button 1105 is a button for returning to the screen of FIG. 8.

FIG. 12 illustrates an example of a screen displayed on the browser of the PC when the transmit button 1004 is selected on the screen of FIG. 8. The screen of FIG. 12 includes a storage button 1002, a copy button 1003, a transmit button 1004, a delete button 1005, a rename button 1006, a back button 1204, and an OK button 1205.

The screen of FIG. 12 illustrates a state in which Folder B is selected in a file selection area 1201 and a list of files stored in Folder B is displayed. The user selects a file to be transmitted from among files 1 to 4. When the file is selected, the file name of the selected file is displayed in a file name display field 1202. The user also inputs the transmission destination in a transmission destination input field 1203.

When the OK button 1205 is selected, the selected file is transmitted from the MFP 100 to the transmission destination input in the transmission destination input field 1203.

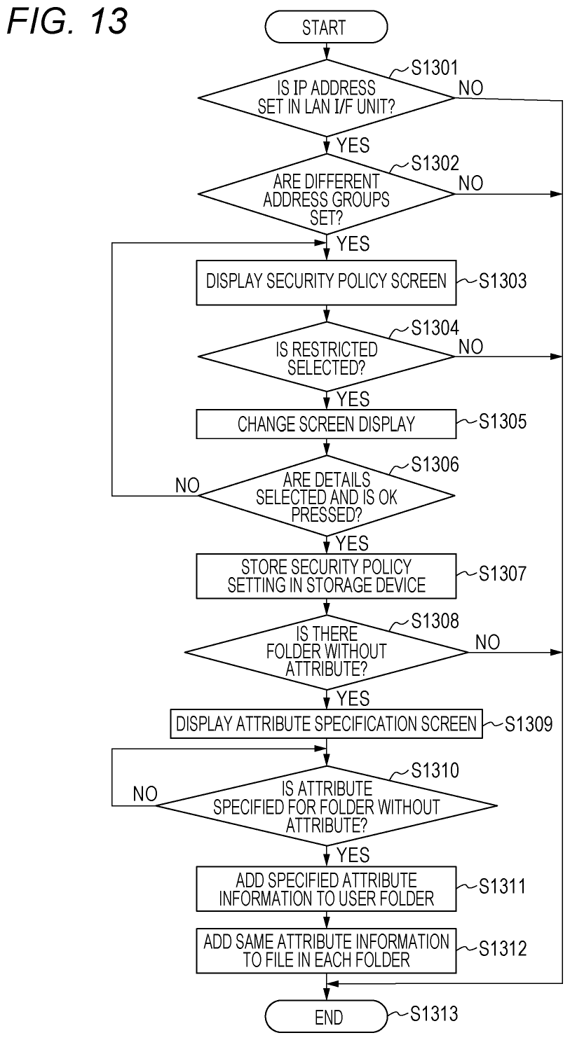

Next, control of the MFP 100 according to the present embodiment will be described with reference to the flowchart of FIG. 13. The flowchart of FIG. 13 is implemented by the CPU 105 reading a program from the storage device 110 into the memory 106 and executing the program.

In S1301, the CPU 105 determines whether an IP address has been set in the LAN-I/F unit 1 or the LAN-I/F unit 2 via a network setting screen (not illustrated). When determining that the setting has been made, the CPU 105 proceeds to S1302. When it is not determined that the setting has been made, the processing terminates.

In S1302, the CPU 105 determines whether different IP address groups are set to the LAN-I/F unit 1 and the LAN-I/F unit 2. This determination is made based on whether or not the network address set to the LAN-I/F unit 1 and the network address set to the LAN-I/F unit 2 are the same. When the addresses are not the same, the CPU 105 determines that different IP address groups have been set. When the addresses are the same, the CPU 105 determines that the same IP address group has been set. When determining that different IP address groups have been set, the CPU 105 proceeds to S1303. When it is determined that the same IP address group has been set, the process terminates.

When different IP address groups are set, the LAN-I/F unit 1 and the LAN-I/F unit 2 are likely to be connected to networks of different organizations as illustrated in FIG. 2. Therefore, in S1303, the CPU 105 causes the operation unit 101 to display the screen illustrated in FIG. 3.

In S1304, the CPU 105 determines whether or not the restricted button 302 has been selected on the screen of FIG. 3. When the back button 305 has been selected, the CPU 105 terminates the process. When the restricted button 302 has been selected, the CPU 105 proceeds to S1305.

In S 1305, the CPU 105 causes the operation unit 101 to display the screen of FIG. 4.

When the “display files/folders” button 401 or the “not display files/folders” button 402 has been selected in S1306 and the OK button 304 has been pressed, the CPU 105 proceeds to S1307. When the OK button has not been pressed, the CPU 105 returns to S1303.

In S1307, the CPU 105 stores the setting information received from the user via the screen of FIG. 4 in the storage device 110.

In S1308, the CPU 105 checks whether there is any folder stored in the storage device 110 to which no network information has been set. When there is such a folder, the CPU 105 proceeds to S1309. When there is no folder, the CPU 105 terminates the process. For example, a folder newly created and to which no network information has yet been specified corresponds to a folder to which no network information has been set. Note that S1308 is not necessarily required but the CPU 105 may proceed to S1309 without making a determination in S 1308.

In S1309, the CPU 105 causes the operation unit 101 to display the screen illustrated in FIG. 5.

In S1310, the CPU 105 displays the screen of FIG. 5 to prompt the user to specify which network information the folders are to have. When determining that network information has been specified to all the folders and the OK button 506 has been pressed, the CPU 105 proceeds to S1311. The determination in S1311 is repeated until the network information is specified.

In S1311, the CPU 105 adds the network information specified in S1310 to the folders. For example, when the LAN 2 has been specified for Folder C, the CPU 105 stores Folder C and the LAN 2 in association with each other in the storage device 110 as shown in Table 1.

In S1312, the CPU 105 adds the same network information to all the files stored in the folder to which the network information was added in S 1311.

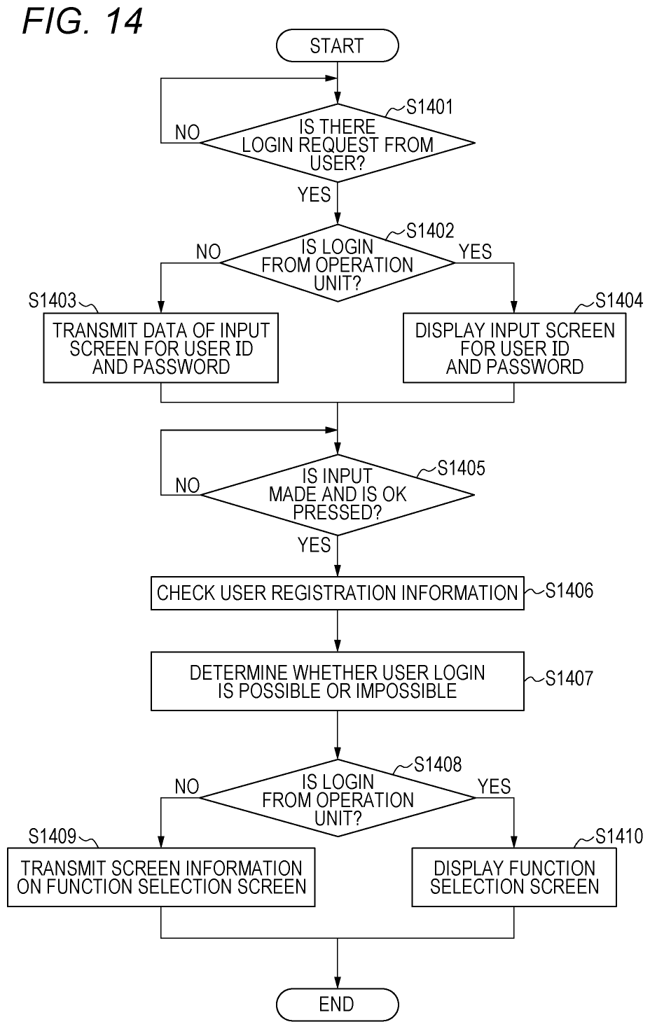

Next, an example of a control performed by the MFP 100 when the user logs into the MFP 100 and operates the folders or files stored in the storage device 110 of the MFP 100 will be described with reference to the flowchart of FIG. 14.

In S1401, the CPU 105 determines whether or not a login request has been received from the user. When a login request has been received from the user, the CPU 105 moves the process to S1402.

In S1402, the CPU 105 determines whether the login request from the user has been received from the operation unit 101 or via a network. The login request is received by the MFP 100 when the login button of the operation unit 101 has been pressed or the browser of the PC has accepted the URL of the top page managed by the web server 120. When the login request from the user has been received from the operation unit 101, the CPU 105 proceeds to S1404. When the login request has been received from a network, the CPU 105 proceeds to S 1403.

In S1403, the CPU 105 transmits login screen information illustrated in FIG. 7 to the PC. At this time, the CPU 105 transmits the login screen information to the PC as the transmission source via the LAN-I/F that has accepted the login request.

In S1404, the CPU 105 causes the operation unit 101 to display a login screen illustrated in FIG. 6.

In S1405, the CPU 105 determines whether a user ID and a password have been input, OK has been selected, and the user ID and password have been accepted on the login screen illustrated in FIG. 6 or the login screen illustrated in FIG. 7. When the user ID and the password have been accepted, the CPU 105 proceeds to S1406. When the user ID and the password have not been accepted, the CPU 105 repeats the processing in S 1405.

In S1406, the CPU 105 checks the user information in Table 2 stored in the storage device 110.

In S1407, the CPU 105 determines whether the user ID and password received from the user are included in the user information stored in the storage device 110, and determines whether or not to allow the user to log into the MFP 100. When not determining to allow login, the CPU 105 terminates the process.

In S1408, the CPU 105 determines whether the login request from the user has been received from the operation unit 101 or via a network. When determining that the login request from the user has been received from the operation unit 101, the CPU 105 proceeds to S1410. On the other hand, when the login request from the user has been received via a network, the CPU 105 proceeds to S1409.

In S1409, the CPU 105 transmits the screen information of the function selection screen illustrated in FIG. 8 to the PC. At this time, the CPU 105 transmits the screen information of the function selection screen to PC as the transmission source via the LAN-I/F that has accepted the login request.

In S1410, the CPU 105 causes the operation unit 101 to display the function selection screen illustrated in FIG. 8.

Then, the CPU 105 terminates the process.

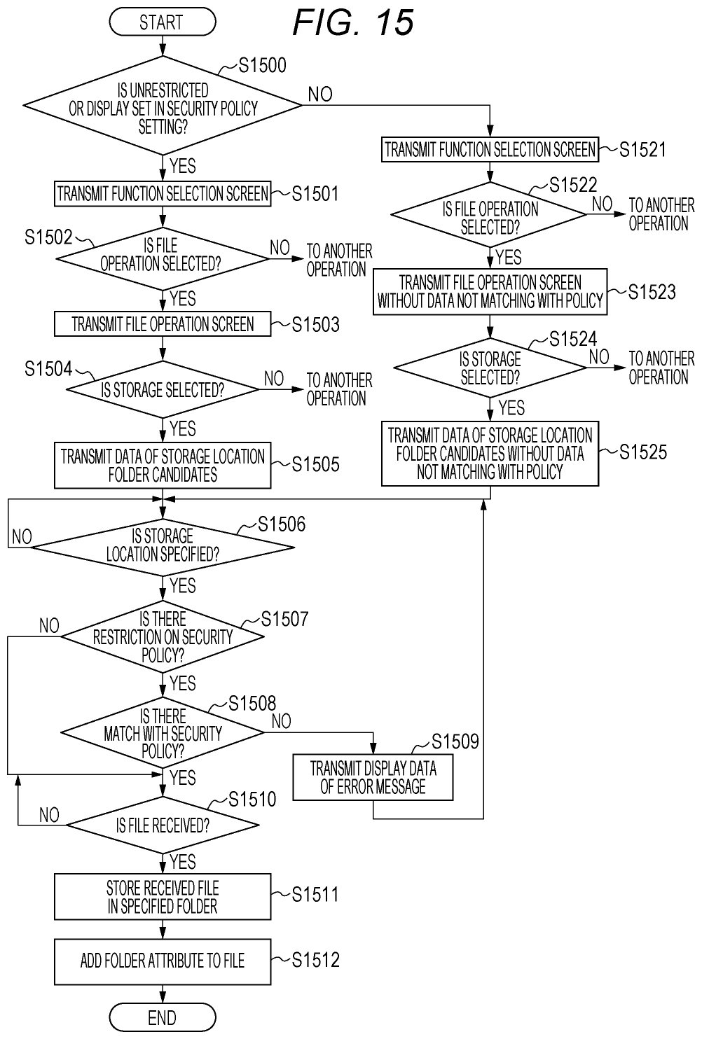

Next, an operation of storing a file from the PC 1 into a folder in the MFP 100 after the user's login from the PC 1 to the MFP 100 will be described with reference to the flowchart of FIG. 15. The flowchart of FIG. 15 is implemented by the CPU 105 reading a program from the storage device 110 to the memory 106 and executing the program. The flowchart of FIG. 15 is executed in accordance with the user's login from the PC 1 to the MFP 100.

In S1500, the CPU 105 determines whether the setting on the screen of FIG. 4 is to display files/folders. When the setting is to display, the CPU 105 proceeds to S1501. When the setting is not to display, the CPU 105 proceeds to S1521.

In S1501, the CPU 105 transmits the data of the function selection screen to the PC 1 through the LAN-I/F unit 1.

In S1502, the CPU 105 determines whether file operation has been selected on the function selection screen of FIG. 8. When file operation has been selected, the CPU 105 proceeds to S1503. Otherwise, the CPU 105 proceeds to another operation.

In S1503, the CPU 105 transmits the file operation screen data to the PC 1.

In S1504, the CPU 105 determines whether the user has selected storage button 1002. When the storage button 1002 has been selected, the MFP 100 accepts a display request for storage location folder candidates, and the CPU 105 proceeds to S1505. Otherwise, the process proceeds to another operation.

In S1505, the CPU 105 transmits data for displaying storage location folder candidates to the PC 1. This data includes all the folders in a first hierarchical level of the MFP 100. In this example, Folder 1, Folder 2 and Folder 3 are displayed.

In S1506, the CPU 105 determines whether a storage location folder has been specified. When the storage location folder has been specified, the CPU 105 proceeds to S1507. Otherwise, the CPU 105 remains in S1506.

In S1507, the CPU 105 determines whether restricted has been set on the screen of FIG. 4. When restricted has been set, the CPU 105 proceeds to step S1508. When restricted has not been set, the CPU 105 proceeds to S1510.

In S1508, the CPU 105 checks whether the operation specified by the user deviates from the network security policy. When there is no deviation, the CPU 105 proceeds to S1510. When there is any deviation, the CPU 105 proceeds to S1509.

In S1509, the CPU 105 transmits data for displaying an error message to the PC 1. Then, the CPU 105 proceeds to S1506.

In S1510, the CPU 105 determines whether a file to be stored has been received. When a file to be stored has been received, the CPU 105 proceeds to S1511. When a file to be stored has not been received or has been being received, the CPU 105 remains in S1510.

In S1511, the CPU 105 stores the received file in the storage folder.

In S1512, the CPU 105 adds the attribute information of the storage folder to the stored file.

In S1521, the CPU 105 transmits data of the function selection screen to the PC 1 through the LAN-I/F unit 1.

In S1522, the CPU 105 determines whether the file operation button 806 has been selected on the function selection screen. When the file operation button has been selected, the CPU 105 proceeds to S1523. Otherwise, the CPU 105 proceeds to another operation.

In this case, the PC 1 has logged into the MFP 100. Therefore, the CPU 105 recognizes that transmission and reception of data with the MFP 100 are performed via the LAN-I/F unit 1. Therefore, in S1523, the CPU 105 refers to Table 1 and transmits to the PC 1 the data of the operation screen including the information of the folders to which the LAN 1 corresponding to the LAN-I/F unit 1 has been set and excluding the information of the folders to which the LAN-I/F 2 has been set. In the example of Table 1, the folders in which the LAN 1 has been set are Folder 1 and Folder 2, and the folder in which LAN2 has been set is Folder 3. The PC 1 displays the operation screen based on the operation screen data. The user selects a folder or selects a file stored in the folder to perform a file storage operation or a file deletion operation.

In S1524, the CPU 105 determines whether the user has selected storage. When storage has been selected, the CPU 105 proceeds to S1525. Otherwise, the CPU 105 proceeds to another operation.

In S1525, the CPU 105 refers to Table 1 and transmits to the PC 1 operation screen data not including the information of the folders to which the LAN-I/F 2 is set but including the information of the folders to which the LAN 1 corresponding to the LAN-I/F unit 1 is set. In the example of Table 1, the folders to which LAN 1 is set are Folder 1 and Folder 2, and the folder to which LAN2 is set is Folder 3. The PC 1 displays the operation screen based on the operation screen data, and receives from the user the selection of the folder as the storage location of the image data. Then, the CPU 105 proceeds to step S1506.

Described above are the operations of the user logging from the PC 1 to the MFP 100 and then storing a file from the PC 1 to a folder in the MFP 100. Performing the foregoing control makes it possible to hide the folders that the user of the PC 1 does not have the right to use from the user.

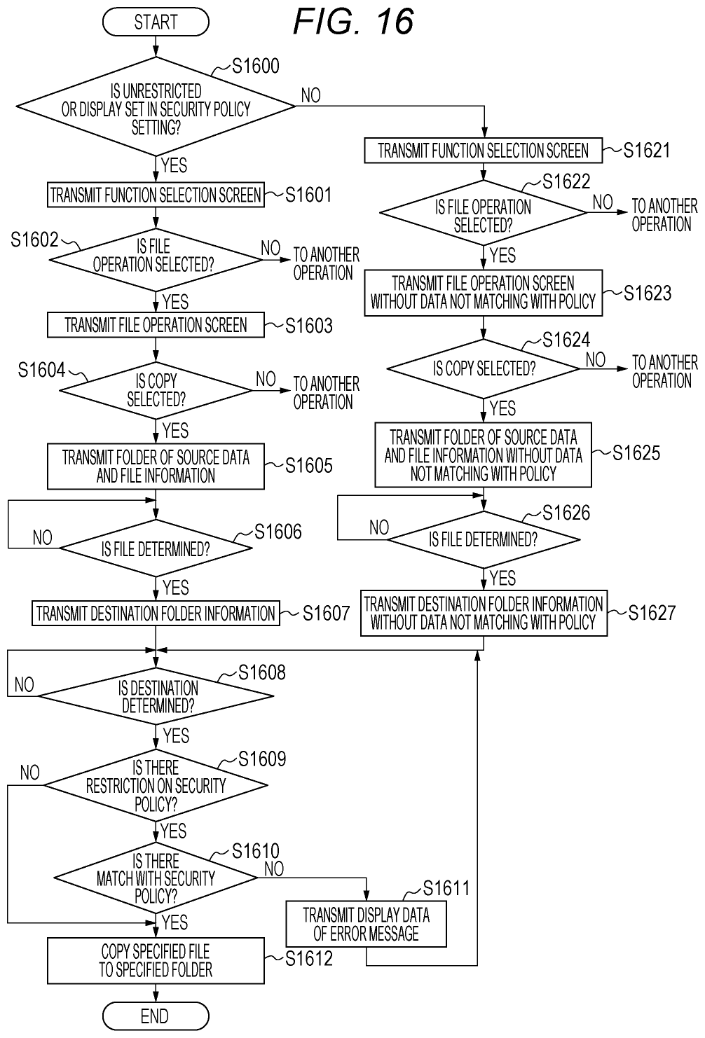

Next, an operation of prohibiting file copy to a folder will be described with respect to the flowchart of FIG. 16. The flowchart of FIG. 16 is implemented by the CPU 105 reading a program from the storage device 110 to the memory 106 and executing the same. The flowchart of FIG. 16 is executed in accordance with the login of the user from the PC 1 to the MFP 100.

In S 1600, the CPU 105 determines whether the setting on the screen of FIG. 4 is to display files/folders. When the setting is to display, the CPU 105 proceeds to S1601, and when the setting is not to display, the CPU 105 proceeds to S 1621.

In S1601, the CPU 105 transmits data of the function selection screen to the PC 1 through the LAN-I/F unit 1.

In S1602, the CPU 105 determines whether the file operation button 806 has been selected on the function selection screen. When the file operation button 806 has been selected, the CPU 105 proceeds to S1603. Otherwise, the CPU 105 proceeds to another operation.

In S1603, the CPU 105 transmits the file operation screen data to the PC 1.

In S1604, the CPU 105 determines whether the user has selected the copy button 1003. When the copy button 1003 has been selected, the CPU 105 proceeds to S1605. Otherwise, the CPU 105 proceeds to another operation.

In S1605, the CPU 105 transmits to the PC 1 data for displaying the copy source folder and file candidates through the LAN-I/F unit 1.

In S1606, the CPU 105 determines whether the copy source file has been decided. When the copy source file has been decided, the CPU 105 proceeds to S1607. The CPU 105 repeats the determination in S1605 until it is determined that the copy source file has been decided.

In S1607, the CPU 105 transmits the data for displaying the copy destination folder candidates to the PC 1 through the LAN-I/F unit 1.

In S1608, the CPU 105 determines whether the copy destination folder has been decided. When the copy destination folder has been decided, the CPU 105 proceeds to S1609. The CPU 105 repeats the processing in S1608 until determining that the copy destination folder has been decided.

In S1609, the CPU 105 determines whether restricted has been set on the screen of FIG. 4. When there is restriction, the CPU 105 proceeds to S1610. When there is no restriction, the CPU 105 proceeds to S1612.

In S1610, the CPU 105 checks whether the operation specified by the user deviates from the setting described in FIG. 5. When there is no deviation, the CPU 105 proceeds to S1612. When there is any deviation, the CPU 105 proceeds to S1611.

In S1611, the CPU 105 transmits data for displaying an error message to the PC 1 illustrated in FIG. 2. Then, the process proceeds to S 1608.

In S1612, the CPU 105 copies the file specified by the user to the specified folder.

When the CPU 105 proceeds the process from S1600 to S1621, the CPU 105 transmits data of the function selection screen to the PC 1 through the LAN-I/F unit 1 in S1621.

In S1622, the CPU 105 determines whether the file operation button 806 has been selected on the function selection screen. When the file operation button 806 has been selected, the CPU 105 proceeds to S1623. Otherwise, the CPU 105 proceeds to another operation.

In S1623, the CPU 105 transmits to the PC 1 file operation screen data excluding file and folder information not in conformity with the network security policy.

In S1624, the CPU 105 determines whether the user has selected copy. When copy has been selected, the CPU 105 proceeds to S1625. Otherwise, the CPU 105 proceeds to another operation.

In S1625, the CPU 105 transmits data for displaying the copy source folder and file candidates excluding the file and folder information not in conformity with the network security policy to the PC 1 through the LAN-I/F unit 1.

In S1626, the CPU 105 determines whether the copy source file has been decided. When the copy source file has been decided, the CPU 105 proceeds to S1627. The CPU 105 remains in S1626 until determining that the copy source file has been decided.

In S1627, the CPU 105 transmits data for displaying the copy destination folder candidates excluding the folder information not in conformity with the network security policy to the PC 1 through the LAN-I/F unit 1. Then, the CPU 105 proceeds to S 1608.

Although the foregoing description is about the file copy operation, a similar operation is performed for file transfer, for example. In addition, since the file copy operation described above can be performed from the PC or from the operation unit 101 in the same manner without a difference in the control flow. Thus, the description of a file copy operation from the operation unit 101 will be omitted.

Next, a case where the user logs in from the operation unit 101 of the image processing apparatus 100 to perform a file operation will be described. The user needs to be authenticated to use the image processing apparatus 100 as is conventionally done.

A user A registered as a LAN 1 user logs in from the operation unit 101 of the image processing apparatus 100, uses the reading unit 108 to read an original document, and stores the read data in Folder B of the user folder 112 in the storage device 110. Then, an operation of transmitting scan data to the PC 1 will be described. The following description is based on the condition that the settings of FIG. 4 in the present example are restricted and not display files/folders.

The operation of the user logging in from the operation unit 101 has been described above with reference to FIGS. 7 and 14. For example, when the user A can log into both the networks, both the login destinations may be displayed so that the user can select either one of them as described above. On the other hand, when the user A is allowed to log into only one of the networks, only the available login destination may be displayed in response to an input of the user ID.

Next, an operation of reading an original document using the reading unit 108 and storing the read data in the user folder 112 in the storage device 110 will be described. Also in this case, selecting the file operation button 806 on the function selection screen of FIG. 8, selecting storage as illustrated in FIG. 10, and selecting the storage button 1002 makes it possible to store the data in the specified folder. At this time, although Folder C is displayed as storage destination in FIG. 10, the storage destination may not be displayed based on the network security policy setting. Specifically, this is enabled by selecting not display files/folders in the network security policy.

In the example described below, an operation of transferring data stored in Folder B to the PC 1 illustrated in FIG. 2 will be described including a process flow in the case where not display files/folders is set in the network security policy described above.

When the function selection screen of FIG. 8 is displayed from the received data on the screen of the PC 1, the user selects the function to be used. When the user selects the file operation button 806 and presses the OK button 604, the PC 1 transmits the data input by the user to the image processing apparatus 100.

The CPU 105 receives data through the LAN-I/F unit 1 and determines that the user has selected file operation. Then, the CPU 105 transmits the file operation screen data illustrated in FIG. 10 to the PC 1 illustrated in FIG. 2 through the LAN-I/F unit 1.

The PC 1 illustrated in FIG. 2 displays the file operation screen of FIG. 10 received from the image processing apparatus 100.

When the user selects the copy function 1003 and presses OK 604, the PC 1 transmits the data input by the user to the image processing apparatus 100. The description of the operation when a function other than the storage function is selected will be omitted here.

The CPU 105 receives the data through the LAN-I/F unit 1 and determines that the user has selected transmit button 1004. Then, the CPU 105 transmits to the PC 1 data for displaying the transmission source folder and file candidates through the LAN-I/F unit 1.

The PC 1 displays the data received from the image processing apparatus 100 on the PC screen. When the user specifies the transmission source folder and file, the PC 1 transmits the information of the folder and file to the image processing apparatus 100.

The CPU 105 transmits screen display data for inputting a transmission destination through the LAN-I/F unit 1 to the PC 1 illustrated in FIG. 2.

The PC 1 displays the data received from the image processing apparatus 100 on the PC screen. When the user inputs information of a transmission destination (for example, an IP address or the like), the PC 1 transmits the information to the image processing apparatus 100.

The CPU 105 receives the transmission destination information through the LAN-I/F unit 1.

The CPU 105 checks whether the image processing apparatus 100 is set to be restricted in the network security policy. The CPU 105 also checks whether the operation specified by the user and the specified folder information and transmission destination information deviate from the network security policy specified in the image processing apparatus 100.

When the file in Folder B specified by the user is given the attribute of LAN 1 and the IP address specified as the transmission destination is not an address in LAN 1, the CPU 105 does not permit the copy operation but transmits an error message to the PC 1 illustrated in FIG. 2.

When determining that the information conforms the network security policy, the CPU 105 transmits the file specified by the user to the specified IP address.

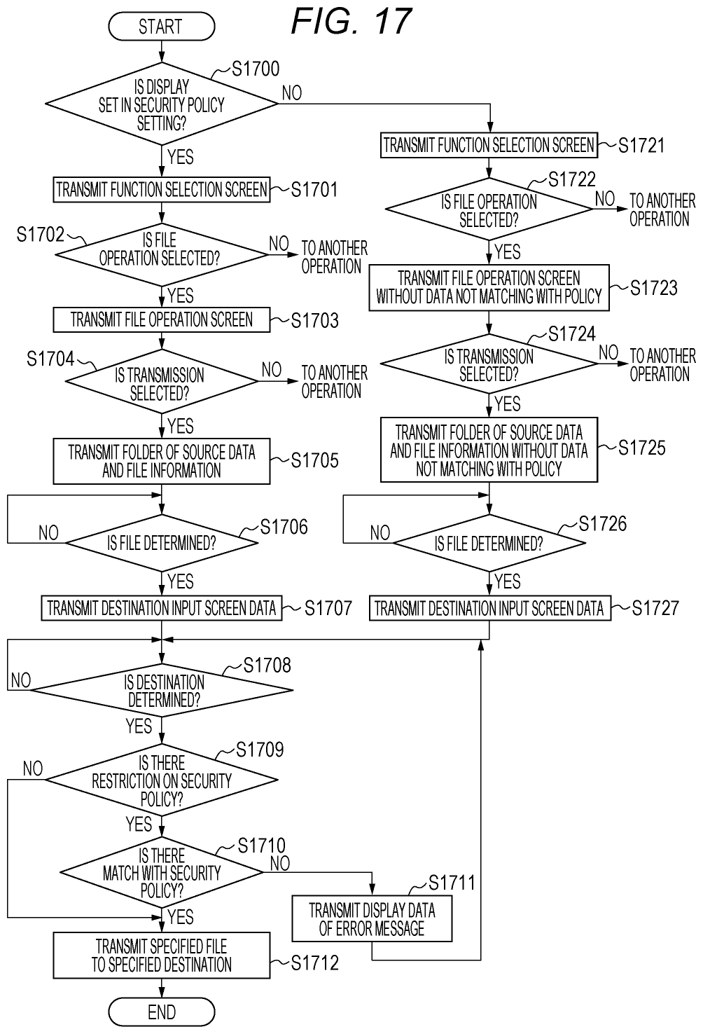

Hereinafter, operations of the CPU 105 will be described with reference to the flowchart of FIG. 17.

In S1700, the CPU 105 determines whether display files/folders is set in the network security policy setting. When display is set, the CPU 105 proceeds to step S1701, and when not display is set, the CPU 105 proceeds to step S1721.

In S1701, the CPU 105 transmits the data of the function selection screen to the PC 1 illustrated in FIG. 2 through the LAN-I/F unit 1.

In S1702, the CPU 105 determines whether file operation has been selected on the function selection screen. When file operation has been selected, the CPU 105 proceeds to step S1703. Otherwise, the CPU 105 proceeds to another operation.

In S1703, the CPU 105 transmits file operation screen data to the PC 1 illustrated in FIG. 2.

In S1704, the CPU 105 determines whether the user has selected transmission. When transmission is selected, the CPU 105 proceeds to step S1705. Otherwise, the process proceeds to another operation.

In S1705, the CPU 105 transmits data for displaying the transmission source folder and file candidates through the LAN-I/F unit 1 to the PC 1 illustrated in FIG. 2.

In S 1706, the CPU 105 determines whether the transmission source file has been decided. When the transmission source file has been decided, the CPU 105 proceeds to S 1707. The CPU 105 remains in S1706 until determining that the transmission source file has been decided.

In S 1707, the CPU 105 transmits screen display data for inputting a transmission destination through the LAN-I/F unit 1 to the PC 1 illustrated in FIG. 2.

In S1708, the CPU 105 determines whether the transmission destination has been input and confirmed. When the transmission destination has been confirmed, the CPU 105 proceeds to S1709. The CPU 105 remains in S1708 until determining that the transmission destination has been confirmed.

In S1709, the CPU 105 determines whether restricted has been set in the network security policy. When restricted has been set, the CPU 105 proceeds to step S1710. When restricted has not been set, the CPU 105 proceeds to step S1712.

In S1710, the CPU 105 checks whether the operation specified by the user deviates from the network security policy. When there is no problem, the CPU 105 proceeds to step S1712. When there is a problem, the CPU 105 proceeds to step S1711.

In S1711, the CPU 105 transmits data for displaying an error message to the PC 1 illustrated in FIG. 2. Then, the CPU 105 proceeds to step S1708.

In S1712, the CPU 105 transmits the file specified by the user to the specified destination.

In S1721, the CPU 105 transmits the data of the function selection screen to the PC 1 illustrated in FIG. 2 through the LAN-I/F unit 1.

In S1722, the CPU 105 determines whether file operation has been selected on the function selection screen. When file operation has been selected, the CPU 105 proceeds to step S1723. Otherwise, the CPU 105 proceeds to another operation.

In S1723, the CPU 105 transmits to the PC 1 illustrated in FIG. 2 file operation screen data excluding file and folder information not in conformity with the network security policy.

In S1724, the CPU 105 determines whether the user has selected transmission. When storage has been selected, the CPU 105 proceeds to step S1725. Otherwise, the CPU 105 proceeds to another operation.

In S1725, the CPU 105 transmits data for displaying the transmission source folder and file candidates excluding the file and folder information not in conformity with the network security policy to the PC 1 illustrated in FIG. 2 through the LAN-I/F unit 1.

In S 1726, the CPU 105 determines whether the transmission source file has been decided. When the transmission source file has been decided, the CPU 105 proceeds to S1727. The CPU 105 remains in S1726 until determining that the transmission source file has been decided.

In S1727, the CPU 105 transmits screen display data for inputting a transmission destination through the LAN-I/F unit 1 to the PC 1 illustrated in FIG. 2. Then, the CPU 105 proceeds to S 1708.

Since the file transmission operation described above can be performed remotely from the PC or from the operation unit 101 in the same manner without a difference in the control flow. Thus, the description of a file transmission operation from the operation unit 101 will be omitted.

In relation to the foregoing example, the user folder 112 is described as a folder associated with the LAN-I/F. As a similar method, partitions in the storage device 110 may be assigned to each LAN-I/F so that user folders are stored there. Further, a plurality of HDDs may be assigned to each LAN-I/F. In these cases, since the areas for storing the folders for storing user data are different from one another in the external storage devices. Accordingly, when partitions or external storage devices are associated with LAN-I/Fs, folder processing can be performed without adding attribute information to the folders.

As described above, the security policy in the operations of the image processing apparatus is set for each network, the folders or partitions for storing user data in the image processing apparatus are divided for each network, and the attributes of the networks are provided to the folders or partitions. Files stored in folders or partitions are provided with the same attributes as those provided to the folders or partitions. The security of the data stored in the image processing apparatus can be ensured by restricting file or folder operations in accordance with the security policy and the attributes of the folders or files. For example, it is determined whether or not to restrict the operation (communication) relating to folders. According to the determination on the restriction, it is possible to restrict the communication for displaying (viewing) a list of the restricted folders, or restrict the communication for access to the restricted folders (viewing internal data), or restrict access to the data in the restricted folders.

### Other Embodiments

The present disclosure supplies a program that implements one or more functions of the above-described embodiments to a system or apparatus via a network or a storage medium. The functions can also be implemented by one or more processors in a computer in the system or apparatus reading and executing the program. Further, the functions can also be implemented by a circuit that implements one or more functions (for example, an ASIC).

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-113944, filed Jun. 14, 2018, which is hereby incorporated by reference herein in its entirety.

What is claimed is:

1. An information processing apparatus with a plurality of network interfaces comprising:
at least one controller configured to function as,
a unit that associates network information related to any one of the plurality of network interfaces with a folder that stores data;
a second unit that determines, based on at least the network information, whether or not to permit an external device that communicates with the information processing apparatus via a network corresponding to the network information to perform predetermined communication relating to the folder.

2. The information processing apparatus according to claim 1, wherein
the predetermined communication is communication for viewing information of the folder on the external device.

3. The information processing apparatus according to claim 1, wherein
the at least one controller transmits information of the folder as web page data to the external device in the predetermined communication.

4. The information processing apparatus according to claim 1, wherein
the predetermined communication is communication for viewing list information of data in the folder on the external device.

5. The information processing apparatus according to claim 1, wherein
the at least one controller transmits list information of the data in the folder as web page data to the external device in the predetermined communication.

6. The information processing apparatus according to claim 1, wherein
the predetermined communication is communication for the external device to acquire the data in the folder.

7. The information processing apparatus according to claim 1, further comprising
a display device for displaying information,
wherein the at least one controller causes the display device to display a screen for specifying network information to be associated with the folder.

8. The information processing apparatus according to claim 7, wherein
the screen is a screen on which the network information to be associated with the folder is specifiable from a pull-down menu.

9. The information processing apparatus according to claim 1, wherein
the information processing apparatus is operable in one of a first mode in which the folder is desired to be associated with network information and a second mode in which the folder is not desired to be associated with network information.

10. A control method for controlling an information processing apparatus with a plurality of network interfaces, the control method comprising:
associating network information related to any one of the plurality of network interfaces with a folder that stores data; and
determining, based on at least the network information, whether or not to permit the external device that communicates with the information processing apparatus via a network corresponding to the network information to perform predetermined communication relating to the folder.

11. The control method for controlling an information processing apparatus according to claim 10, wherein
the predetermined communication is communication for viewing information of the folder on the external device.

12. The control method for controlling an information processing apparatus according to claim 10, wherein
the at least one controller transmits information of the folder as web page data to the external device in the predetermined communication.

13. The control method for controlling an information processing apparatus according to claim 10, wherein
the predetermined communication is communication for viewing list information of data in the folder on the external device.

14. The control method for controlling an information processing apparatus according to claim 10, wherein
the at least one controller transmits the list information of data in the folder as web page data to the external device in the predetermined communication.

15. The control method for controlling an information processing apparatus according to claim 10, wherein
the predetermined communication is communication for the external device to acquire the data in the folder.

16. The control method for controlling an information processing apparatus according to claim 10, further comprising
a display device for displaying information,
wherein the at least one controller causes the display device to display a screen for specifying network information to be associated with the folder.

17. The control method for controlling an information processing apparatus according to claim 16, wherein
the screen is a screen on which the network information to be associated with the folder is specifiable from a pull-down menu.

18. The control method for controlling an information processing apparatus according to claim 10, wherein
the information processing apparatus is operable in one of a first mode in which the folder is desired to be associated with network information and a second mode in which the folder is not desired to be associated with network information.

19. A recording medium in which a program for causing a computer to execute a control method for controlling an information processing apparatus with a plurality of network interfaces is recorded, the control method comprising:
associating network information related to any one of the plurality of network interfaces with a folder that stores data; and
determining, based on at least the network information, whether or not to permit the external device that communicates with the information processing apparatus via the network corresponding to the network information to perform predetermined communication relating to the folder.
